(19) United States
(12) Patent Application Publication
(10) Pub. No.: US 2007/0097144 A1
(43) Pub. Date: May 3, 2007

(54) Resampling individual fields of video information using a programmable graphics processing unit to provide improved full rate displays

(75) Inventor: Sean Matthew Gies, Campbell, CA (US)

Correspondence Address: WONG, CABELLO, LUTSCH, RUTHERFORD & BRUCCULERI,;L.L.P., 20333 SH 249, SUITE 600, HOUSTON, TX, 77070, US

(73) Assignee: Apple Computer, Inc., Cupertino, CA (US)

(21) Appl. No.: 11/261,721

(22) Filed: Oct. 27, 2005

(51) Int. Cl. G09G 5/00

(52) U.S. Cl. 345/606

(57) ABSTRACT

A system which utilizes the processing capabilities of the graphics processing unit (GPU) in the graphics controller. Each interlaced video field is resampled to provide full resolution and then displayed at full rate. The field pixel values are resampled as appropriate using the GPU to provide values corresponding to the locations missing from that field. The resampled values and the original values are provided to the frame buffer for final display for each field. Each of these operations is done in real time for each field of the video. Because each field has had the values resampled to provide a value for the missing locations from the other field, the final displayed image is both full resolution and full rate. In an alternate embodiment, the values of the preceding and following fields are included in the resampling operation to improve still object rendition.

### RELATED APPLICATIONS

The subject matter of the invention is generally related to the following jointly owned and co-pending patent applications: “Display-Wide Visual Effects for a Windowing System Using a Programmable Graphics Processing Unit” by Ralph Brunner and John Harper, Ser. No. 10/877,358, filed Jun. 25, 2004, “Resampling Chroma Video Using a Programmable Graphics Processing Unit to Provide Improved Color Rendering” by Sean Gies, Ser. No. ______ filed concurrently herewith, and “Resampling Selected Colors of Video Information Using a Programmable Graphics Processing Unit to Provide Improved Color Rendering on LCD Displays” by Sean Gies, Ser. No. ______, filed concurrently herewith, which are incorporated herein by reference in their entirety.

### BACKGROUND

The invention relates generally to computer display technology and, more particularly, to the application of visual effects using a programmable graphics processing unit during frame-buffer composition in a computer system.

Presentation of video on digital devices is becoming more common with the increases in processing power, storage capability and telecommunications speed. Programs such as QuickTime by Apple Computer, Inc., allow the display of various video formats on a computer. In operation, QuickTime must decode each frame of the video from its encoded format and then provide the decoded image to a compositor in the operating system for display.

Display of interlaced video on non-interlaced computer displays has always been problematic. The simplest technique is to simply drop all even or odd fields and reduce the frame rate by one-half, for example to 30 Hz. If the image resolution is also decreased, say to 320×240, the loss of resolution is not as noticeable. But the frame rate is slow enough to be perceptible and the smaller image size is generally undesirable.

One improvement is to combine both the even and odd fields into a single progressively scanned frame. This potentially provides better resolution, but still reduces the frame rate by one-half. Further, artifacts are created for moving objects because of the position change of the object that occurs between fields, which are then displayed simultaneously.

It would be beneficial to provide a mechanism by which interlaced video images are displayed at full frame rate and at full resolution without movement artifacts.

### SUMMARY

A system according to the present invention utilizes the processing capabilities of the graphics processing unit (GPU) in the graphics controller. Each field is resampled to provide full resolution and then displayed at full rate. The field pixel values are resampled as appropriate using the GPU to provide values corresponding to the locations missing from that field. The resampled values and the original values are provided to the frame buffer for final display for each field, with offsets or shifts being included if necessary. Each of these operations is done in real time for each field of the video. Because each field has had the values resampled to provide a value for the missing locations from the other field, the final displayed image is both full resolution and full rate. In an alternate embodiment, the values of the preceding and following fields are included in the resampling operation to improve still object rendition.

### BRIEF DESCRIPTION OF THE DRAWINGS

FIG. 1 shows an illustration of a computer system with various video sources and displays.

FIG. 2 shows an exemplary block diagram of the computer of FIG. 1.

FIG. 3 illustrates the original sampling locations, conventional image development and resampled image development according to the present invention.

FIG. 4 shows an exemplary software environment of the computer of FIG. 1.

FIG. 5 shows a flowchart of operation of video software according to the present invention.

FIGS. 6A and 6B show operations and data of a graphics processing unit for first and second embodiments according to the present invention.

### DETAILED DESCRIPTION

Methods and devices to provide real time video deinterlacing using fragment programs executing on a programmable graphics processing unit are described. The following embodiments of the invention, described in terms of the Mac OS X window server and compositing application and the QuickTime video application, are illustrative only and are not to be considered limiting in any respect. (The Mac OS X operating system and QuickTime are developed, distributed and supported by Apple Computer, Inc. of Cupertino, Calif.)

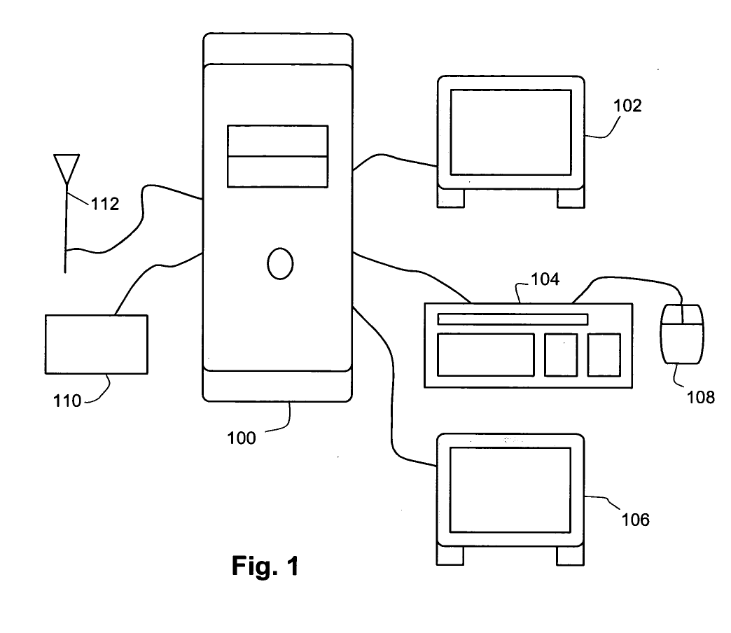

Referring now to FIG. 1, a computer system is shown. A computer 100, such as a PowerMac G5 from Apple Computer, Inc., has connected a monitor or graphics display 102 and a keyboard 104. A mouse or pointing device 108 is connected to the keyboard 104. A video display 106 is also connected for video display purposes in certain embodiments. The display 102 is more commonly used for video display, and then it is usually done in a window in the graphic display.

A video camera 110 is shown connected to the computer 100 to provide a first video source. A cable television device 112 is shown as a second video source for the computer 100.

It is understood that this is an exemplary computer system and numerous other configurations and devices can be used.

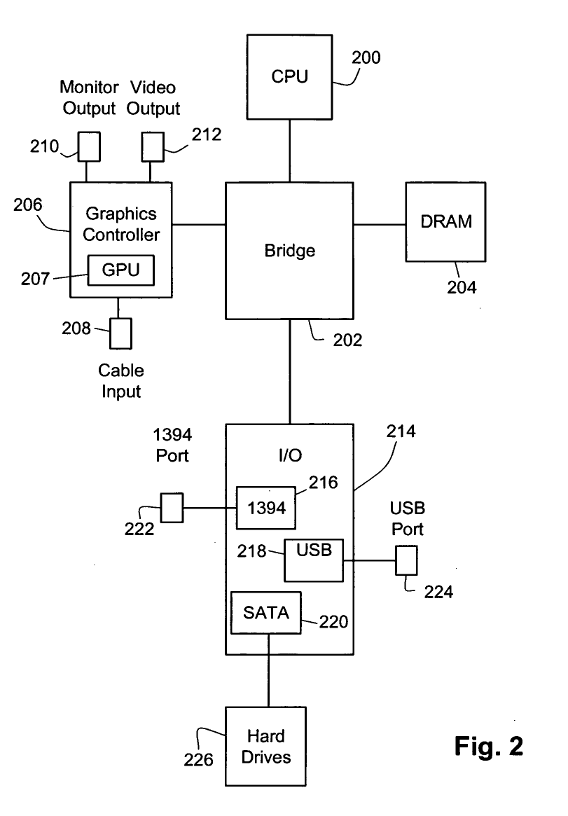

Referring to FIG. 2, an exemplary block diagram of the computer 100 is shown. A CPU 200 is connected to a bridge 202. DRAM 204 is connected to the bridge 202 to form the working memory for the CPU 200. A graphics controller 206, which preferably includes a graphics processing unit (GPU) 207, is connected to the bridge 202. The graphics controller 206 is shown including a cable input 208, for connection to the cable device 112; a monitor output 210, for connection to the graphics display 102; and a video output 212, for connection to the video display 106.

An I/O chip 214 is connected to the bridge 202 and includes a 1394 or FireWire™ block 216, a USB (Universal Serial Bus) block 218 and a SATA (Serial ATA) block 220. A 1394 port 222 is connected to the 1394 block 216 to receive devices such as the video camera 110. A USB port 224 is connected to the USB block 218 to receive devices such as the keyboard 104 or various other USB devices such as hard drives or video converters. Hard drives 226 are connected to the SATA bock 220 to provide bulk storage for the computer 100.

It is understood that this is an exemplary block diagram and numerous other arrangements and components could be used.

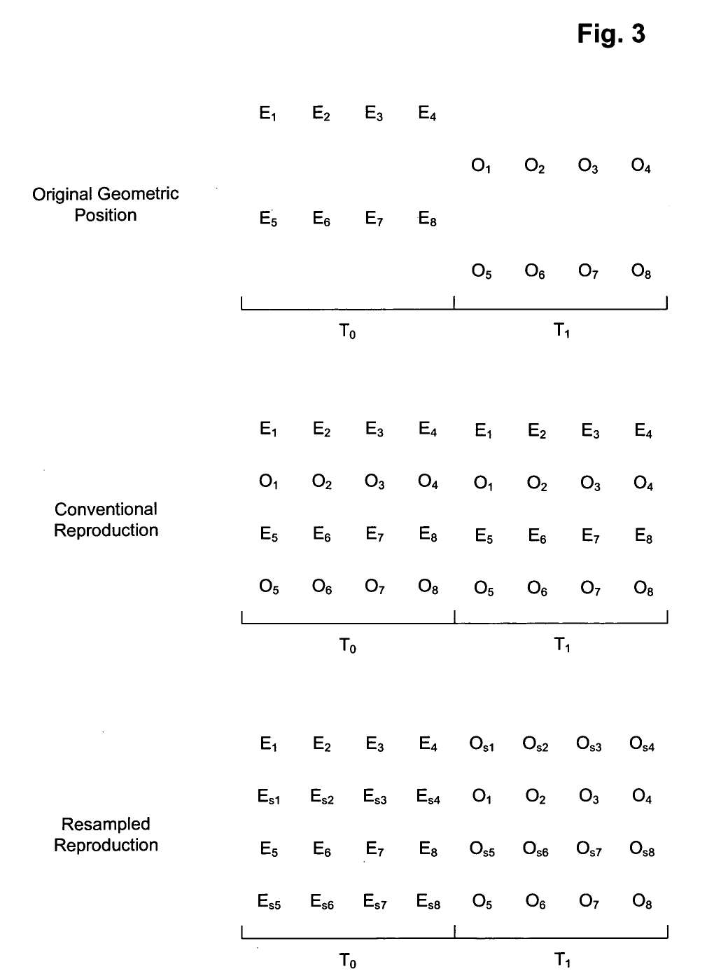

Referring then to FIG. 3, various aspects of interlaced video display are illustrated. The first row is the geometric position of the original image pixels for even and odd fields, showing both the space and time separations. The second row is a graphic illustrating the conventional reproduction technique. The final row is the results according to the present invention.

Referring to FIG. 3, the first row illustrates the original position and timing of the pixels of the even and odd fields of the illustrated example. In this case there are four pixels from each of two rows for each of the two fields. The displacement vertically between the even and odd values is the offset of the two fields, while the displacement horizontally is the time difference between the even field and the odd field.

The second row illustrates conventional reproduction on a progressive, non-interlaced display. It can be seen that the even and odd samples are placed to be occurring at the same time in the display and so are directly over each other. This can also be seen by the fact that there is only one vertical column in this second row. This is an indication that the frame rate is one-half, i.e., in the United States it would be 30 frames per second typically, for example. Thus it can be readily seen that any movement that would occur between the even field and the odd field is collapsed, so that while the even field would be sampled at time T and the odd field would be sampled at time T plus one, the display of the fields is combined to one time period, so that in reality this a mixed time display. As stated in the background, this can cause artifacts in images which contain moving objects.

Referring then to the third row of FIG. 3, an illustration of an image produced using resampling according to the present invention is shown. As can be seen, the original even and odd fields are reproduced identically to their original positions and times, one in a first field time frame and one in a second field time frame. However, it can also be seen that additional pixel values have been provided to fill up the effective missing rows from the other field. Preferably in a first embodiment, they are developed by resampling from adjacent pixel values according to a desired sampling algorithm, such as linear or sinc, where the sinc function is

$$\{ \begin{matrix}\frac{sin ( x )}{x} & x \neq 0 \\ 1 & x = 0\end{matrix} .$$

Thus, for the second row of the even field the pixels Eₛ₁, Eₛ₂, Eₛ₃ and Eₛ₄ for even sample 1 through even sample 4 are provided. Similarly the fourth row of the even field contains sampled values. Further similarly, the first row of the odd field and the third row of the odd field are also developed by resampling odd field pixel values in this first embodiment. Therefore it can be seen that a full set of pixels, i.e., a full image, is provided with this resampling. Because this is done on each field at the full frame rate, i.e., 60 Hz in the U.S. for example, a full resolution and full frame rate video stream is developed.

In a second embodiment, the sampling algorithm used incorporates values from the proceeding and following fields. For example Eₛ₁ or even sample 1 is developed using the values of E₁ and E₅ pixels, as in the first embodiment, but also incorporates factors from O₁, the odd field first pixel value, in both preceding and following frames. This has the advantage of providing better reproduction of still images and yet also providing correction for moving images as well. There may be slightly more computational power required for this embodiment but it is well within the limits provided by the GPU 207 in the preferred embodiments.

It is understood that those are just two exemplary embodiments of resampling to develop missing rows. Other resampling techniques, which might utilize additional prior and subsequent fields, can be used if desired.

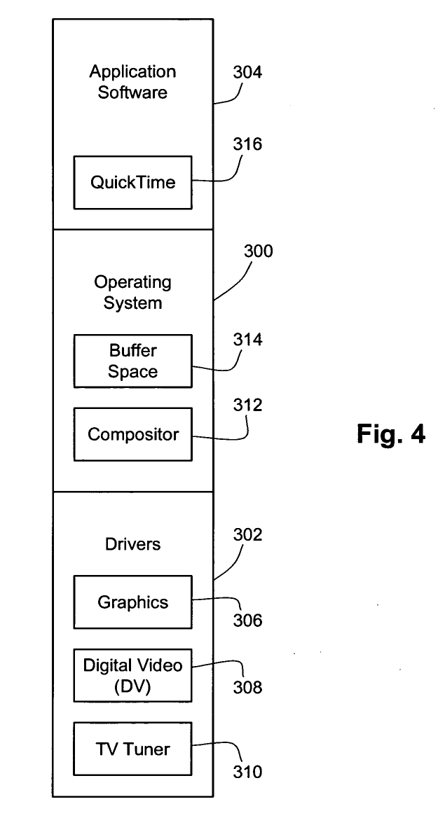

Referring them to FIG. 4, a drawing of exemplary software present on the computer 100 is shown. An operating system, such as Mac OS X by Apple Computer, Inc., forms the core piece of software. Various device drivers 302 sit below the operating system 300 and provide interface to the various physical devices. Application software 304 runs on the operating system 300.

Exemplary drivers are a graphics driver 306 used with the graphics controller 206, a digital video (DV) driver 308 used with the video camera 110 to decode digital video, and a TV tuner driver 310 to work with the graphics controller 206 to control the tuner functions.

Particularly relevant to the present invention are two modules in the operating system 300, specifically the compositor 312 and buffer space 314. The compositor 312 has the responsibility of receiving the content from each application for that application's window and combining the content into the final displayed image. The buffer space 314 is used by the applications 304 and the compositor 312 to provide the content and develop the final image.

The exemplary application is QuickTime 316, a video player program in its simplest form. QuickTime can play video from numerous sources, including the cable, video camera and stored video files.

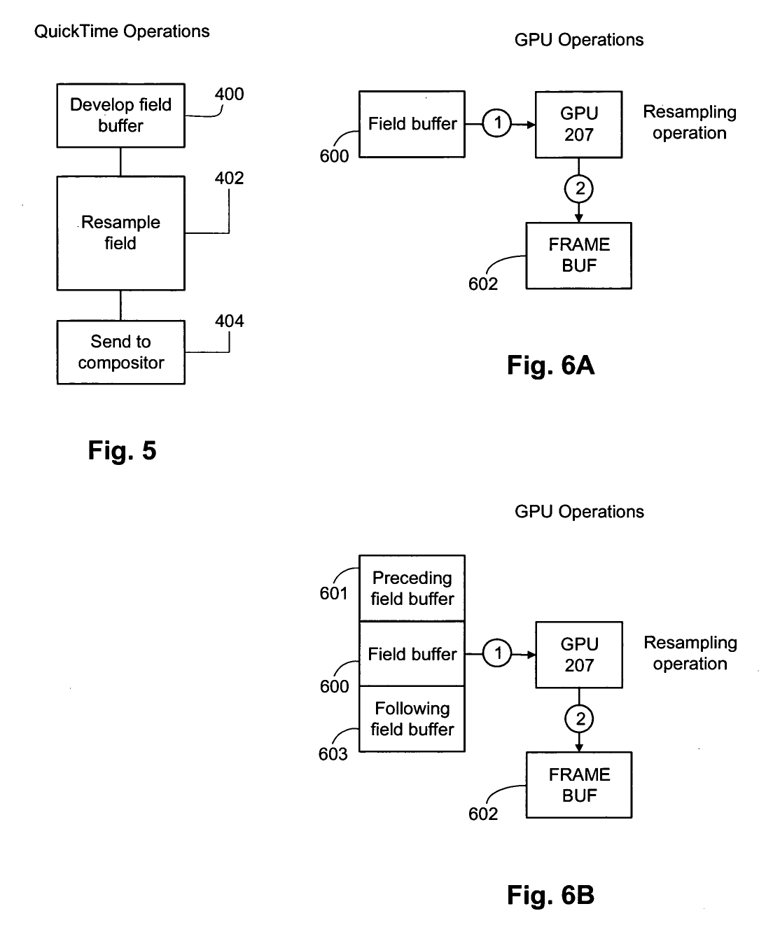

Having set this background, and referring then to FIG. 5, the operations of the QuickTime application 316 are illustrated. In step 400 the QuickTime application 316 decodes the video and develops a buffer containing the field. This can be done using conventional techniques. Further, the video can come from real time sources or from a stored or streaming video file. After the QuickTime application 316 develops the field buffer in step 400, the field pixel values are resampled as described above by using fragment programs on the GPU to provide pixel values for each location. In step 404 this buffer with the resampled field values is provided to the compositor. It is also understood that these steps are performed for each field in the video.

Referring then to FIG. 6A, an illustration of the various data sources and operations of the GPU 207 are shown. A field buffer 600 is provided to the GPU 207 in operation \textcircled{1}. Then in operation \textcircled{2} the GPU 207 resamples the field pixel values using the proper resampling fragment program and renders the buffer to the frame buffer 602. FIG. 6B illustrates operation according to the second embodiment of the invention. In this case the preceding field buffer 601 and following field buffer 603 are also provided to the GPU 207 to allow the other field information to be used in the resampling operation as described above.

The various buffers can be located in either the DRAM 204 or in memory contained on the graphics controller 206, though the frame buffer is almost always contained on the graphics controller for performance reasons.

Thus an efficient method of performing field resampling from video source to final display device has been described. Use of the GPU and its fragment programs provides sufficient computational power to perform the operations in real time, as opposed to the CPU, which cannot perform the calculations in real time. Therefore, because of the resampling of the field pixel values, the video is displayed at full resolution and full frame rate in a non-interlaced manner.

Various changes in the components as well as in the details of the illustrated operational methods are possible without departing from the scope of the following claims. For instance, in the illustrative system of FIGS. 1, 2 and 3 there may be additional assembly buffers, temporary buffers, frame buffers, field buffers and/or GPUs. In addition, acts in accordance with FIGS. 6A and 6B may be performed by two or more cooperatively coupled GPUs and may, further, receive input from one or more system processing units (e.g., CPUs). It will further be understood that fragment programs may be organized into one or more modules and, as such, may be tangibly embodied as program code stored in any suitable storage device. Storage devices suitable for use in this manner include, but are not limited to: magnetic disks (fixed, floppy, and removable) and tape; optical media such as CD-ROMs and digital video disks (“DVDs”; and semiconductor memory devices such as Electrically Programmable Read-Only Memory (“EPROM”), Electrically Erasable Programmable Read-Only Memory (“EEPROM”), Programmable Gate Arrays and flash devices. It is further understood that the video source can be any video source, be it live or stored, and in any video format.

Further information on fragment programming on a GPU can be found in U.S. patent applications Ser. No. 10/826,762, entitled “High-Level Program Interface for Graphics Operations,” filed Apr. 16, 2004 and Ser. No. 10/826,596, entitled “Improved Blur Computation Algorithm,” filed Apr. 16, 2004, both of which are hereby incorporated by reference.

The preceding description was presented to enable any person skilled in the art to make and use the invention as claimed and is provided in the context of the particular examples discussed above, variations of which will be readily apparent to those skilled in the art. Accordingly, the claims appended hereto are not intended to be limited by the disclosed embodiments, but are to be accorded their widest scope consistent with the principles and features disclosed herein.

What is claimed is:

1. A method for displaying interlaced digital video on a non-interlaced display device, comprising:
decoding interlaced digital video information into pixel values for each field;
resampling the decoded pixel values to provide resampled pixel values for the lines missing from the field; and
providing an image containing the decoded pixel values and the resampled pixel values at full frame rate for each field.

2. The method of claim 1, wherein the resampling is performed using a linear function.

3. The method of claim 1, wherein the resampling is performed based on the sinc function.

4. The method of claim 1, wherein the step of resampling includes resampling just the decoded pixel values for a field to provide the resampled pixel values for that field.

5. The method of claim 1, wherein the step of resampling includes resampling the decoded pixel values for a field and decoded pixel values of adjacent fields to provide the resampled pixel values for that field.

6. The method of claim 1, wherein the resampling is performed in a graphics processing unit.

7. A computer readable medium or media having computer-executable instructions stored therein for performing the following method for displaying digital video on a display device, the method comprising:
decoding interlaced digital video information into pixel values for each field;
resampling the decoded pixel values to provide resampled pixel values for the lines missing from the field; and
providing an image containing the decoded pixel values and the resampled pixel values at full frame rate for each field.

8. The computer readable medium or media of claim 7, wherein the resampling is performed using a linear function.

9. The computer readable medium or media of claim 7, wherein the resampling is performed based on the sinc function.

10. The computer readable medium or media of claim 7, wherein the step of resampling includes resampling just the decoded pixel values for a field to provide the resampled pixel values for that field.

11. The computer readable medium or media of claim 7, wherein the step of resampling includes resampling the decoded pixel values for a field and decoded pixel values of adjacent fields to provide the resampled pixel values for that field.

12. The computer readable medium or media of claim 7, wherein the resampling is performed in a graphics processing unit

13. A computer system comprising:
a central processing unit;
memory, operatively coupled to the central processing unit, said memory adapted to provide a plurality of buffers, including a frame buffer;
a display port operatively coupled to the frame buffer and adapted to couple to a display device;
a graphics processing unit, operatively coupled to the memory; and
one or more programs for causing the graphics processing unit to perform the following method, the method including:
decoding interlaced digital video information into pixel values for each field;
resampling the decoded pixel values to provide resampled pixel values for the lines missing from the field; and
providing an image containing the decoded pixel values and the resampled pixel values at full frame rate for each field.

14. The computer system of claim 13, wherein the resampling is performed using a linear function.

15. The computer system of claim 13, wherein the resampling is performed based on the sinc function.

16. The computer system of claim 13, wherein the step of resampling includes resampling just the decoded pixel values for a field to provide the resampled pixel values for that field.

17. The computer system of claim 13, wherein the step of resampling includes resampling the decoded pixel values for a field and decoded pixel values of adjacent fields to provide the resampled pixel values for that field.
